(19) United States
(12) Patent Application Publication
(10) Pub. No.: US 2026/0339677 A1
(43) Pub. Date: Oct. 29, 2026

(54) DYNAMIC CUSTOMIZATION FOR MULTI-METAVERSE ENVIRONMENTS

(71) Applicant: International Business Machines Corporation, Armonk, NY (US)

(72) Inventors: Michael BOONE, Lutz, FL (US); Jessica NAHULAN, Vaughan (CA); Sarbajit Kumar RAKSHIT, Kolkata (IN); Carolina GARCIA DELGADO, Zapopan (MX)

(21) Appl. No.: 19/188,486

(22) Filed: Apr. 24, 2025

(51) Int. Cl. G06F 9/445

(52) U.S. Cl. CPC G06F 9/44505

(57) ABSTRACT

In some implementations, a computer may identify multiple first metaverse environments that are each associated with an event. The computer may obtain one or more customization rules for a second metaverse environment associated with the event, wherein the one or more customization rules indicate one or more first participation ratios. The computer may configure the second metaverse environment based on the one or more customization rules and the multiple first metaverse environments. The computer may obtain, based on user interaction information in the second metaverse environment, one or more interaction parameters for a user participating in the second metaverse environment. The computer may modify, based on the one or more interaction parameters, the one or more customization rules to obtain one or more second participation ratios. The computer may configure the second metaverse environment based on the one or more second participation ratios.

### BACKGROUND

This disclosure relates to virtual worlds, and more specifically, to dynamic customization for multi-metaverse environments.

### SUMMARY

Some aspects described herein relate to a method. The method may include identifying multiple first metaverse environments that are each associated with an event. The method may include obtaining one or more customization rules for a second metaverse environment associated with the event, where the one or more customization rules indicate one or more first participation ratios for respective metaverse environments from the multiple first metaverse environments. The method may include configuring the second metaverse environment based on the one or more customization rules and the multiple first metaverse environments. The method may include obtaining, based on user interaction information in the second metaverse environment, one or more interaction parameters for a user participating in the second metaverse environment, where the one or more interaction parameters indicate at least one of an excitement level or an interaction level. The method may include modifying, based on the one or more interaction parameters, the one or more customization rules to obtain one or more second participation ratios. The method may include configuring the second metaverse environment based on the one or more second participation ratios.

Some aspects described herein relate to a computer system. The computer system may include a processor set, one or more computer-readable storage media, and program instructions stored on the one or more computer-readable storage media to cause the processor set to perform operations. The operations may include identifying multiple first metaverse environments. The operations may include obtaining one or more customization rules for a second metaverse environment, where the one or more customization rules indicate one or more first participation ratios for respective metaverse environments from the multiple first metaverse environments. The operations may include configuring the second metaverse environment based on the one or more customization rules and the multiple first metaverse environments. The operations may include obtaining, based on user interaction information in the second metaverse environment, one or more interaction parameters for a user participating in the second metaverse environment, where the one or more interaction parameters indicate at least one of an excitement level or an interaction level. The operations may include modifying, based on the one or more interaction parameters, the one or more customization rules to obtain one or more second participation ratios. The operations may include configuring the second metaverse environment based on the one or more second participation ratios.

Some aspects described herein relate to a computer program product. The computer program product may include one or more computer-readable storage media and program instructions stored on the one or more computer-readable storage media to perform operations. The operations may include identifying multiple first metaverse environments. The operations may include obtaining one or more customization rules for a second metaverse environment, where the one or more customization rules indicate one or more first participation ratios for respective metaverse environments from the multiple first metaverse environments. The operations may include configuring the second metaverse environment based on the one or more customization rules and the multiple first metaverse environments. The operations may include obtaining, based on user interaction information in the second metaverse environment, one or more interaction parameters for a user participating in the second metaverse environment, where the one or more interaction parameters indicate at least one of an excitement level or an interaction level. The operations may include modifying, based on the one or more interaction parameters, the one or more customization rules to obtain one or more second participation ratios. The operations may include configuring the second metaverse environment based on the one or more second participation ratios.

### BRIEF DESCRIPTION OF THE DRAWINGS

FIG. 1 is a diagram of an example computing environment for dynamic customization for multi-metaverse environments described herein.

FIGS. 2A-2C are diagrams of an example associated with dynamic customization for multi-metaverse environments.

FIG. 3 is a diagram of example components of a device associated with dynamic customization for multi-metaverse environments.

FIG. 4 is a flowchart of an example process associated with dynamic customization for multi-metaverse environments.

### DETAILED DESCRIPTION

The following detailed description of example implementations refers to the accompanying drawings. The same reference numbers in different drawings may identify the same or similar elements.

Virtual worlds, such as the metaverse, are digital environments that simulate real-world experiences or create new ones. The metaverse is a collective virtual shared space, created by the convergence of virtual reality (VR), augmented reality (AR), the internet, and other technologies. A metaverse environment enables users to interact with each other and digital objects in real time, and is used for various purposes, such as social interaction, entertainment, education, and/or collaboration.

Metaverse events may provide users with unique and immersive experiences by enabling the users to interact with a live event. However, managing multiple metaverse environments incurs high computational complexity, leading to increased resource overhead and reduced system scalability. Existing mechanisms for metaverse event participation may result in statically configured environments, which can lead to inefficient use of network resources and increased latency. Further, mechanisms for metaverse event participation may be limited in their ability to handle multiple registrations, resulting in increased network traffic and reduced system responsiveness.

For example, existing mechanisms for metaverse event participation may result in network congestion due to multiple concurrent registrations, high computational complexity associated with managing multiple environments, and/or inefficient use of resources due to static configurations. Additionally, existing mechanisms for metaverse event participation may result in difficulties in maintaining real-time interaction parameters, resulting in reduced system responsiveness and/or poor user experience. Moreover, statically configured metaverse environments can result in a user participating in a metaverse environment for an event that has a sub-optimal experience for the user. This may result in consumption of resources associated with providing that environment to the user in a sub-optimal manner. For example, the system may consume processing resources, memory resources, and/or network resources, among other examples associated with providing the metaverse environment in which the user has a poor user experience, associated with the user modifying the metaverse environment, and/or associated with the user requesting to register or participate in a different metaverse environment. Furthermore, the static configuration of the metaverse environment can result in inefficient use of storage resources, as users may be presented with environments that are not tailored to preferences or interests. Moreover, existing mechanisms for metaverse event participation may be unable to handle diverse user preferences, resulting in metaverse environments that are not optimized for individual users. This can lead to reduced user engagement, as users may not be presented with environments that are relevant or interesting to them.

Some implementations described herein enable customization of multi-metaverse environments. For example, a server device may identify multiple first metaverse environments associated with an event. The server device may obtain one or more customization rules for a second metaverse environment. The second metaverse environment may be referred to as a “customized” metaverse environment. The one or more customization rules may indicate one or more participation ratios for respective first metaverse environments. A participation ratio may indicate a ratio (or percentage) of participants from a given first metaverse environment (e.g., from the multiple first metaverse environments) that are to participate in the second metaverse environment. As another example, a participation ratio may indicate a ratio (or percentage) of time that a user (e.g., for which the second metaverse environment is configured) is to participate in a given first metaverse environment (e.g., from the multiple first metaverse environments) over a given time period for the second metaverse environment. The server device may configure the second metaverse environment based on the one or more customization rules and the multiple first metaverse environments. For example, the server device may cause a set of participants to be included in the second metaverse environment, where the set of participants are associated with the multiple first metaverse environments, and where a ratio of the set of participants from the multiple first metaverse environments is based on the one or more participation ratios. As another example, the server device may cause an avatar of the user to view the multiple first metaverse environments over a time window, where the amount of time that the avatar views each metaverse environment from the multiple first metaverse environments is based on the one or more participation ratios.

In some examples, the server may obtain one or more interaction parameters for the user participating in the second metaverse environment. The one or more interaction parameters may indicate an excitement level or an interaction level, among other examples, of the user in connection with an interaction within the second metaverse environment. The server device may modify the one or more customization rules based on the one or more interaction parameters to obtain one or more modified participation ratios. The server device may configure (e.g., reconfigure) the second metaverse environment based on the one or more modified participation ratios.

As a result, the techniques described herein may reduce computational complexity associated with managing multiple metaverse environments by configuring participation ratios for multiple first metaverse environments based on, or in accordance with, the one or more customization rules. Additionally, by configuring the second metaverse environment based on the one or more customization rules, the server device may reduce the likelihood of the user submitting a request to modify the second metaverse environment or register for a different metaverse environment. This may conserve network resources, processing resources, and/or memory resources, among other examples, that would have otherwise been associated with modification requests or multiple registrations due to statically configured metaverse environments. Additionally, by the server device dynamically reconfiguring of the second metaverse environment based on the one or more interaction parameters (e.g., real-time interaction parameters), the server device may conserve processing resources, memory resources, and/or network resources, among other examples, that would have otherwise been associated with modification requests or a new registration by the user due to poor user experience or low excitement associated with interaction(s) in the second metaverse environment.

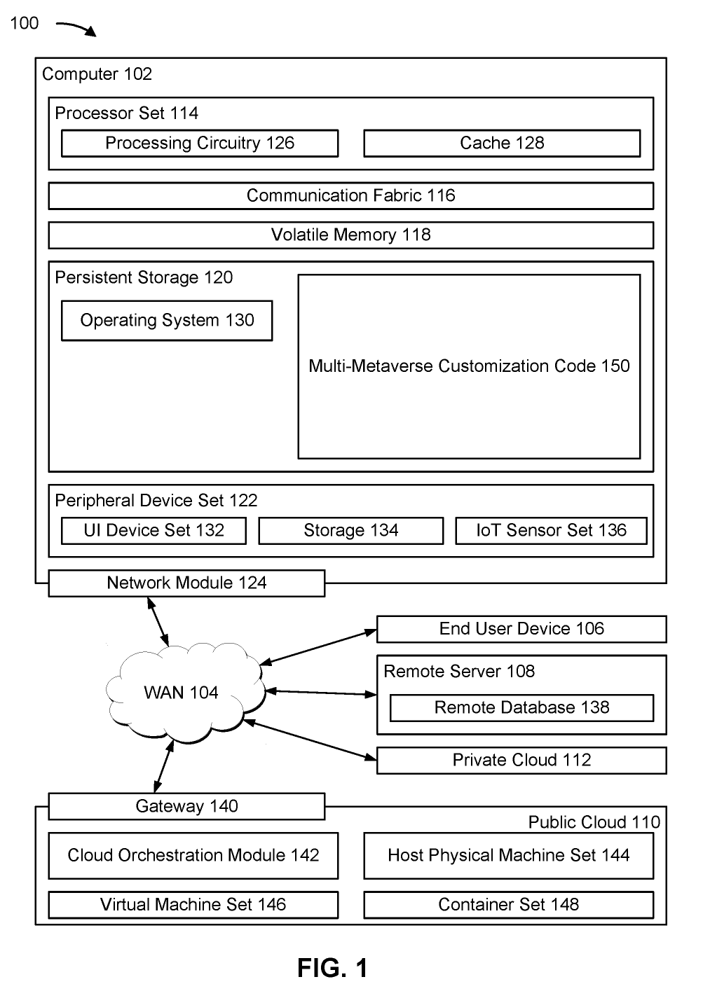

FIG. 1 is a diagram of an example computing environment 100 for dynamic customization for multi-metaverse environments described herein.

The computing environment 100 contains an example of an environment for the execution of at least some of the computer code involved in performing the inventive methods, such as multi-metaverse customization code 150. In addition to the multi-metaverse customization code 150, the computing environment 100 includes, for example, a computer 102, a wide area network (WAN) 104, an end user device (EUD) 106, a remote server 108, a public cloud 110, and a private cloud 112. In this embodiment, the computer 102 includes a processor set 114 (including processing circuitry 126 and a cache 128), communication fabric 116, volatile memory 118, persistent storage 120 (including an operating system 130 and the multi-metaverse customization code 150, as identified above), a peripheral device set 122 (including a user interface (UI) device set 132, storage 134, and an Internet of Things (IoT) sensor set 136), and a network module 124. The remote server 108 includes a remote database 138. The public cloud 110 includes a gateway 140, a cloud orchestration module 142, a host physical machine set 144, a virtual machine set 146, and a container set 148.

The computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as the remote database 138. As is well understood in the art of computer technology, and depending upon the technology, performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, the computer 102 is not required to be in a cloud except to any extent as may be affirmatively indicated.

Computer-readable program instructions are typically loaded onto the computer 102 to cause a series of operational steps to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 128 and the other storage media discussed below. The program instructions, and associated data, are accessed by the processor set 114 to control and direct performance of the inventive methods. In the computing environment 100, at least some of the instructions for performing the inventive methods may be stored in the multi-metaverse customization code 150 in the persistent storage 120.

The communication fabric 116 is the signal conduction path that allows the various components of the computer 102 to communicate with each other. Typically, this fabric is made of switches and electrically conductive paths, such as the switches and electrically conductive paths that make up buses, bridges, and/or physical input / output ports, among other examples. Other types of signal communication paths may be used, such as fiber optic communication paths and/or wireless communication paths, among other examples.

The volatile memory 118 is any type of volatile memory now known or to be developed in the future. Examples include dynamic type random access memory (RAM) or static type RAM. Typically, the volatile memory 118 is characterized by random access, but this is not required unless affirmatively indicated. In the computer 102, the volatile memory 118 is located in a single package and is internal to the computer 102, but, alternatively or additionally, the volatile memory 118 may be distributed over multiple packages and/or located externally with respect to the computer 102.

The code included in the multi-metaverse customization code 150 typically includes at least some of the computer code involved in performing one or more operations described herein. In some implementations, the operations may include identifying multiple first metaverse environments that are each associated with an event; obtaining one or more customization rules for a second metaverse environment associated with the event, where the one or more customization rules indicate one or more first participation ratios for respective metaverse environments from the multiple first metaverse environments; configuring the second metaverse environment based on the one or more customization rules and the multiple first metaverse environments; obtaining, based on user interaction information in the second metaverse environment, one or more interaction parameters for a user participating in the second metaverse environment, where the one or more interaction parameters indicate at least one of an excitement level or an interaction level; modifying, based on the one or more interaction parameters, the one or more customization rules to obtain one or more second participation ratios; and configuring the second metaverse environment based on the one or more second participation ratios.

The peripheral device set 122 includes the set of peripheral devices of the computer 102. Data communication connections between the peripheral devices and the other components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 132 may include components such as a display screen, speaker, microphone, wearable devices (such as goggles and smart watches), keyboard, mouse, printer, touchpad, game controllers, and haptic devices. The storage 134 is external storage, such as an external hard drive, or insertable storage, such as an SD card. The storage 134 may be persistent and/or volatile. In some embodiments, the storage 134 may take the form of a quantum computing storage device for storing data in the form of qubits. In embodiments where the computer 102 is required to have a large amount of storage (for example, where the computer 102 locally stores and manages a large database), then this storage may be provided by peripheral storage devices designed for storing very large amounts of data, such as a storage area network (SAN) that is shared by multiple, geographically distributed computers. The IoT sensor set 136 is made up of sensors that can be used in Internet of Things applications. For example, one sensor may be a thermometer and another sensor may be a motion detector.

The network module 124 is the collection of computer software, hardware, and firmware that allows the computer 102 to communicate with other computers through the WAN 104. The network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to the computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and/or edge servers, among other examples.

The EUD 106 is any computer system that is used and controlled by an end user (for example, a customer of an enterprise that operates the computer 102), and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or otherwise present, the recommendation to an end user. In some embodiments, the EUD 106 may be a client device, such as thin client, heavy client, mainframe computer, and/or desktop computer, among other examples.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 138 of the remote server 108.

The public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of the public cloud 110 is performed by the computer hardware and/or software of the cloud orchestration module 142. The computing resources provided by the public cloud 110 are typically implemented by virtual computing environments that run on various computers making up the computers of the host physical machine set 144, which is the universe of physical computers in and/or available to the public cloud 110. The virtual computing environments (VCEs) typically take the form of virtual machines from the virtual machine set 146 and/or containers from the container set 148. It is understood that these VCEs may be stored as images and may be transferred among and between the various physical machine hosts, either as images or after instantiation of the VCE. The cloud orchestration module 142 manages the transfer and storage of images, deploys new instantiations of VCEs and manages active instantiations of VCE deployments. The gateway 140 is the collection of computer software, hardware, and firmware that allows the public cloud 110 to communicate through the WAN 104.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to the public cloud 110, except that the computing resources are only available for use by a single enterprise. While the private cloud 112 is depicted as being in communication with the WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

Cloud computing services and/or microservices (not separately shown in FIG. 1): private cloud 112 and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

FIG. 1 is provided as an example. Other examples may differ from what is described with regard to FIG. 1.

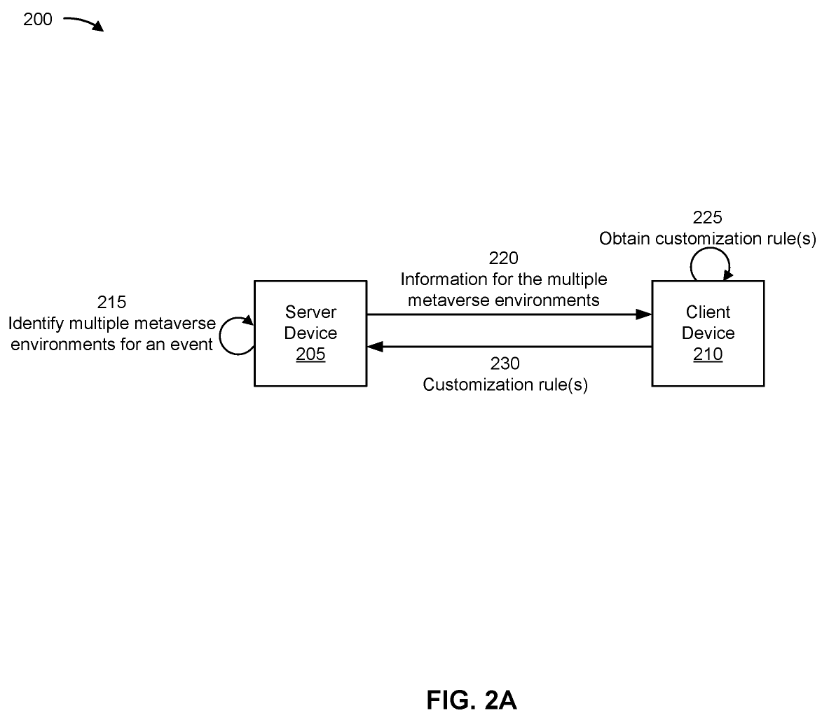

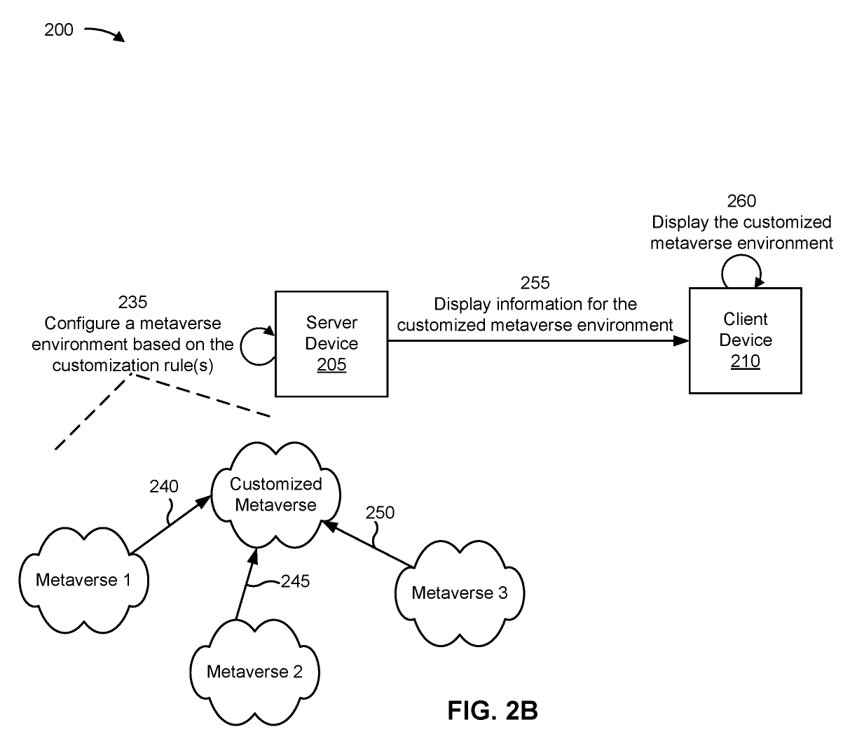

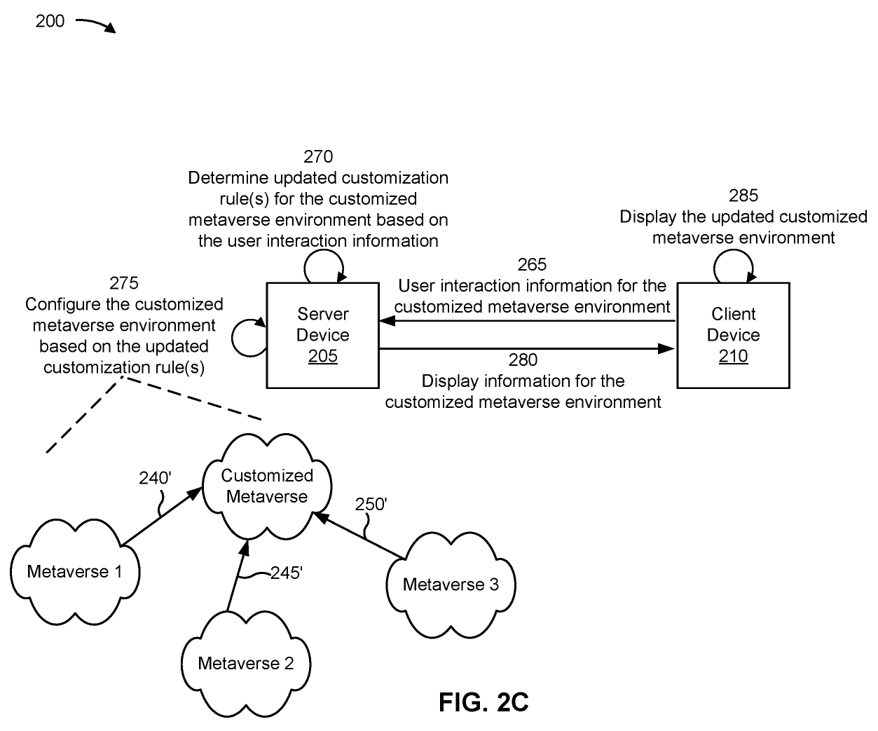

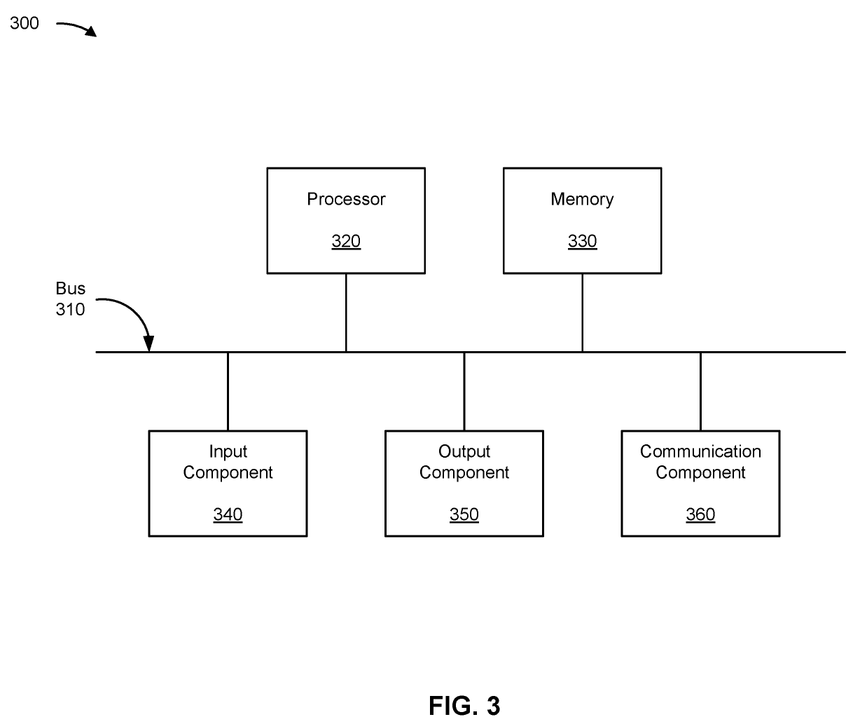

FIGS. 2A-2C are diagrams of an example 200 associated with dynamic customization for multi-metaverse environments. As shown in FIGS. 2A-2C, example 200 includes a server device 205 and a client device 210. These devices are described in more detail in connection with FIGS. 1 and 3. In some examples, the server device 205 is an example of a first computer 102 and the client device is an example of a second computer 102.

The server device 205 may be, or may include, a metaverse server. The metaverse server may be configured to host, manage, and/or facilitate metaverse collaboration sessions, such as generating and adapting personalized virtual layouts described herein. Additionally, the metaverse server may process user input, and/or synchronize interactions among multiple users in real-time, among other examples. Additionally, the metaverse server may perform user authentication, perform data storage for a metaverse environment or session, and/or generate, render, and/or arrange virtual objects and environments, among other examples. The client device 210 may be, or may include, a metaverse client. The metaverse client may be configured to render and/or display personalized virtual layouts received from a metaverse server (e.g., the server device), as described herein. Additionally, the metaverse client may capture and transmit user input, such as movements and interactions, to the server device 205 for processing. The metaverse client may perform local rendering of virtual objects, process sensory data, and/or provide real-time feedback to a user, among other examples.

As shown in FIG. 2A, and by reference number 215, the server device 205 may identify multiple metaverse environments for an event. For example, the server device 205 may identify multiple first metaverse environments that are each associated with the event. For example, the multiple first metaverse environments may be different environments or sessions that are associated with the same event. In some examples, each of the multiple first metaverse environments may include different participants, different virtual objects, and/or different virtual assets, among other examples.

In some examples, each of the multiple first metaverse environments may be associated with metadata that indicates information associated with participants for which that metaverse environment is configured. For example, the metadata may indicate one or more user profiles of participants that are participating in a given metaverse environment. In some examples, the metadata may indicate an interaction mode or discussion mode for a given metaverse environment. The interaction mode or discussion mode may indicate how participants are intended to interact with, or view, the event within a given metaverse environment (e.g., with discussion or collaboration, in silence, or with another type of interaction or discussion). The metadata for a given metaverse environment may include a description for the given metaverse environment that describes the types of participants within the given metaverse environment, a purpose of the given metaverse environment, a description of the event associated with the given metaverse environment, and/or a description of virtual objects or virtual assets included in the given metaverse environment, among other examples. In some examples, the metadata for a given metaverse environment may indicate demographics of participants in the given metaverse environment, an age range of the participants, and/or one or more supporter groups (e.g., for a sporting event) associated with the participants, among other examples.

In some examples, the multiple first metaverse environments may be configured for respective participant groups. For example, the server device 205 may generate or configure the multiple first metaverse environments. In some examples, the server device 205 may design and/or develop separate metaverse environments for each identified participant group. A participant group may be associated with a demographic, an age range, a support group, and/or an interaction or discussion mode, among other examples. The multiple first metaverse environments may include customized virtual spaces, avatars, virtual objects, virtual assets, and/or interactive elements, among other examples, that are configured based on the specific preferences and/or characteristics of each participant group. The server device 205 may configure the multiple first metaverse environments based on the event. For example, the server device 205 may integrate the multiple first metaverse environments with information associated with the event, such as a schedule, a live video feed, and/or real-time event updates, among other examples.

In some examples, the server device 205 may assign a participant to a metaverse environment, from the multiple first metaverse environments, based on a profile of the participant. For example, the server device 205 may register a participant to an appropriate metaverse environment, from the multiple first metaverse environments, based on information associated with the participant, such as a demographic, age group, regulated restrictions, and/or supporter affiliation, among other examples. In some examples, the server device 205 may obtain and/or store profiles with participation preferences for respective participants. The profile may indicate the demographic, age group, regulated restrictions, and/or supporter affiliation, among other examples for the participant.

In some examples, the event may be an event for which multiple participants attend and/or interact with the event. For example, the event may be a sporting event. In such examples, the multiple metaverse environments may be environments or sessions in which groups of participants are viewing the sporting event. For example, a first metaverse environment may include participants that support a first team participating in the sporting event and a second metaverse environment may include participants that support a second team participating in the sporting event.

As another example, the event may be a virtual conference. In such examples, the multiple metaverse environments may be environments or sessions for different courses, speeches, talks, and/or meetings, among other examples, associated with the conference. In some examples, the multiple metaverse environments may be environments or sessions for viewing a given course, speech, talk, and/or meeting associated with the conference. As another example, the event may be a virtual concert or virtual music festival. For example, a virtual music festival may include several stages, each hosting different performances within distinct metaverse environments. For example, a given metaverse environment (e.g., from the multiple first metaverse environments) may include, or display, a virtual stage for the virtual music festival.

As shown by reference number 220, the server device 205 may transmit, and the client device 210 may receive, information for the multiple metaverse environments (e.g., the multiple first metaverse environments). For example, the information for the multiple metaverse environments may include the metadata associated with the multiple metaverse environments. In some examples, the information for the multiple metaverse environments indicate an interaction mode or discussion mode for a given metaverse environment. The information for a given metaverse environment may include a description for the given metaverse environment that describes the types of participants within the given metaverse environment, a purpose of the given metaverse environment, a description of the event associated with the given metaverse environment, and/or a description of virtual objects or virtual assets included in the given metaverse environment, among other examples.

The server device 205 transmitting the information for the multiple metaverse environments may enable the client device 210 to provide or display a user interface that enables a user to customize a presence in a second metaverse environment (e.g., associated with the event) by selecting various combinations of participants from the first metaverse collaborative environments. For example, the client device 210 may display a visualization of the multiple first metaverse environments. The visualization may indicate profiles, avatars, virtual assets, event information, and/or participant details, among other examples, of respective metaverse environments. For example, the visualization may indicate the information for the multiple metaverse environments. In some examples, the visualization may indicate interaction information for the multiple metaverse environments. The interaction information may indicate an excitement level, an enjoyment level, feedback information, and/or other information associated with interactions by participants within the multiple metaverse environments. This enables a user to select and/or configure the metaverse environment in which they wish to participate for the event based on the information for the multiple metaverse environments.

As shown by reference number 225, the client device 210 may obtain one or more customization rules for the second metaverse environment. In some examples, the client device 210 may obtain a user input indicating the one or more customization rules. For example, based on the visualization of the multiple first metaverse environments, the user may input (e.g., to the client device) the one or more customization rules. The one or more customization rules may indicate participation information for the user for the second metaverse environment. The participation information may be based on the information for the multiple first metaverse environments. For example, the one or more customization rules may indicate one or more first participation ratios for respective metaverse environments from the multiple first metaverse environments. A participation ratio may indicate a ratio of participants, virtual objects, or virtual assets from a given metaverse environment that are to participate in the second metaverse environment. Additionally, or alternatively, a participation ratio may indicate a ratio of time that the user (e.g., for which the second metaverse environment is being configured and/or customized) is to participate with the participants, virtual objects, or virtual assets from a given metaverse environment.

For example, the customization of the second metaverse environment may include the user setting different participation ratios for participants from different metaverse environments (e.g., from the multiple first metaverse environments) in the second metaverse environment. The user may select or input one or more participation ratios of participants from various first metaverse environment. This enables the user to adjust their presence in the second metaverse by specifying ratios or preferences for combining participants from different first metaverse environments for the event. For example, the one or more customization rules may indicate that the second metaverse environment is to include 30% participants from metaverse environment 1, 40% from metaverse environment 1, and 30% from metaverse environment 1.

Additionally, or alternatively, the one or more customization rules may include avatar customization for the user, such as a customization of appearance, clothing, or accessories, based on user preferences or event context. Additionally, or alternatively, the one or more customization rules may include environment customization rules. The environment customization rules may indicate one or more environmental settings for the second metaverse environment, such as lighting, sound, an/or special effects, among other examples, that may be customizable to create a specific atmosphere or ambiance. Additionally, or alternatively the one or more customization rules may include one or more interaction rules. The one or more interaction rules may indicate types of permissible interactions within the second metaverse environment, such as text chat, voice chat, and/or gesture-based interactions, among other examples.

Additionally, or alternatively, the one or more customization rules may include content filtering rules, event scheduling rules, and/or virtual asset management rules, among other examples. For example, one or more content filtering rules can be set to filter out specific types of content, such as explicit language or mature themes. One or more event scheduling rules can define the timing and/or reminders for events, such as conferences, meetups, and/or performances, among other examples. One or more virtual asset management rules may define how virtual assets, such as three-dimensional (3D) models, textures, and/or audio files, can be used within the second metaverse environment.

Additionally, or alternatively, the one or more customization rules may include user roles and permissions, social interaction rules, event feedback and rating, accessibility options, monetization and sponsorship, and/or security and moderation rules, among other examples. For example, user roles and permissions may indicate permitted user roles, such as moderator, administrator, or guest, and what actions they can perform within the second metaverse environment. The one or more customization rules may indicate accessibility options, such as text-to-speech, font size adjustment, and/or color scheme changes, among other examples.

In some implementations, as shown by reference number 230, the client device 210 may transmit, and the server device 205 may receive, the one or more customization rules. For example, the server device 205 may obtain the one or more customization rules for the second metaverse environment associated with the event. In some examples, the server device 205 may receive an indication of one or more participation ratios for respective metaverse environments from the multiple first metaverse environments for the event. In some examples, the server device 205 may obtain a user input indicating the one or more participation ratios. For example, the user input may be provided to the client device 210. The user input may be indicated by the client device 210 to the server device 205.

Additionally, or alternatively, the server device 205 may determine the one or more customization rules based on historical interactions of the user for one or more historical multi-metaverse environments. A “multi-metaverse” environment may refer to an environment in which multiple metaverse environments or sessions exist for a given event. For example, the server device 205 may obtain information indicating how the user interacted with, participated in, and/or moved between (e.g., moved between different metaverse environments), among other examples, as part of the one or more historical multi-metaverse environments.

To determine the customization rules and/or participation ratios based on historical interactions as part of the one or more historical multi-metaverse environments, the server device 205 may analyze the historical interactions with multi-metaverse environments. For example, the server device 205 may process a dataset of user behavior, including interaction patterns, navigation behaviors, and/or engagement metrics, among other examples, associated with the one or more historical multi-metaverse environments. The server device 205 may obtain the dataset from various sources, such as log files, user feedback forms, and/or analytics tools, among other examples. The dataset may include metrics, such as time spent in different metaverse environments, frequency of interactions with specific users or objects, navigation patterns between environments, and/or one or more interaction parameters (e.g., excitement level, engagement level, and/or user rating), among other examples. The server device 205 can then use this data to identify trends, preferences, and/or patterns in the behavior of the user in association with the one or more historical multi-metaverse environments.

Based on the analysis, the server device 205 may determine or generate one or more customization rules and/or one or more participation ratios tailored to the preferences and/or historical interactions of the user. For example, the server device 205 may determine that a user tends to engage more frequently with participants from a specific metaverse environment, and therefore adjust the participation ratio to prioritize interactions with participants from that environment. As a result, the server device 205 can determine one or more customization rules and/or one or more participation ratios that are based on historical interactions of the user with multi-metaverse environments, providing a more personalized and engaging experience. Additionally, this may enable customization of the second metaverse environment without the user input, thereby conserving network resources, processing resources, and/or memory resources, among other examples, that would have otherwise been associated with obtaining and/or communicating the user input.

In some implementations, the server device 205 may provide an indication of the one or more customization rules to a rule-sharing platform, such as a social media platform. The server device 205 may integrate with the rule-sharing platform, enabling the server device 205 to share customization rules with other devices, such as client devices 210 or other client devices or server devices not shown in FIG. 2A. Additionally, or alternatively, the client device 210 may provide an indication of the one or more customization rules to the rule-sharing platform. The client device 210 may include a user interface, such as a graphical user interface (GUI), that enables the client device 210 to receive user input for selecting and sharing customization rules with other multi-metaverse environment participants.

After the client device 210 or the server device 205 provides the customization rule to the rule-sharing platform, the server device 205 may establish communication between devices, including chat, voice, and video features, to enhance the collaborative experience. The server device 205 may integrate with one or more social networks, enabling the server device 205 to connect with client devices 210 and share the one or more customization rules for the second metaverse environment.

In some examples, the server device 205 may include a recommendation system that analyzes customization rules and suggests them to client devices 210 based on similarities in preferences and interests. For example, if the server device 205 receives a customization rule for the second metaverse environment that combines elements from multiple first metaverse environments, the recommendation system may suggest this rule to another client device 210 that is associated with a participant that has shown interest in similar types of multi-metaverse environments. The server device 205 may provide a platform for sharing customization rules, such as via a social network platform, enabling a collaborative and social experience within the multi-metaverse environment for the event.

As shown in FIG. 2B, and by reference number 235, the server device 205 may configure a metaverse environment (e.g., the second metaverse environment) based on the one or more customization rules. For example, the server device 205 may generate a customized metaverse environment based on the one or more customization rules and the multiple first metaverse environments.

In some examples, configuring the customized metaverse environments may include the server device 205 causing a set of participants to be included in the second metaverse environment. The set of participants may be associated with (e.g., participating in) the multiple first metaverse environments. A ratio of the set of participants from the multiple first metaverse environments may be based on the one or more participation ratios indicated by the one or more customization rules.

For example, as shown in FIG. 2B, the multiple first metaverse environments may include a metaverse 1, a metaverse 2, and a metaverse 3, among other examples. The one or more customization rules may indicate that the metaverse 1 is associated with a participation ratio 240, the metaverse 2 is associated with a participation ratio 245, and the metaverse 3 is associated with a participation ratio 250. A first ratio of participants included in the customized metaverse environment from the metaverse 1 may be indicated by the participation ratio 240 (e.g., if the participation ratio 240 is X%, then X% of the participants in the customized metaverse environment may be from the metaverse 1). Similarly, a second ratio of participants included in the customized metaverse environment from the metaverse 2 may be indicated by the participation ratio 245 (e.g., if the participation ratio 245 is Y%, then Y% of the participants in the customized metaverse environment may be from the metaverse 2). A third ratio of participants included in the customized metaverse environment from the metaverse 3 may be indicated by the participation ratio 250 (e.g., if the participation ratio 250 is Z%, then Z% of the participants in the customized metaverse environment may be from the metaverse 3).

Additionally, or alternatively, configuring the customized metaverse environments may include the server device 205 causing an avatar of the user to view the multiple first metaverse environments over a time window. For example, an amount of time that the avatar views each metaverse environment, from the multiple first metaverse environments, may be based on the one or more first participation ratios, such as the participation ratio 240, the participation ratio 245, and/or the participation ratio 250. For example, the server device 205 may dynamically move the avatar between various metaverse environments (e.g., from the multiple first metaverse environments) based on, or in accordance with, the one or more participation ratios indicated by the one or more customization rules. For example, over the time window, the server device 205 may cause the avatar of the user to be present in the metaverse 1 for X% of the time window (e.g., if the participation ratio 240 is X%), in the metaverse 2 for Y% of the time window (e.g., if the participation ratio 245 is Y%), and in the metaverse 2 for Z% of the time window (e.g., if the participation ratio 250 is Z%).

Additionally, or alternatively, configuring the customized metaverse environments may include the server device 205 causing one or more virtual components (e.g., a virtual avatar, a virtual object, a virtual asset, a tool, and/or a service) from the multiple first metaverse environments to be available in the second metaverse environment. For example, a ratio of which metaverse environments the one or more virtual components are from is based on the one or more first participation ratios, such as the participation ratio 240, the participation ratio 245, and/or the participation ratio 250 (e.g., in a similar manner as described above).

Additionally, or alternatively, configuring the customized metaverse environments may include the server device 205 configuring an avatar for the user, setting one or more environment parameters, and/or other configurations of the customized metaverse environments based on the one or more customization rules. For example, the server device 205 may utilize a real-time rendering engine that is configured to generate the customized metaverse environment based on the one or more customization rules. The real-time rendering engine may dynamically adjust the placement and/or interaction of participants (e.g., from the multiple first metaverse environments, such as the metaverse 1, the metaverse 2, and/or the metaverse 3) based on the one or more customization rules. The may enable the user to interact with the customized metaverse environment and one or more participants (e.g., from the multiple first metaverse environments, such as the metaverse 1, the metaverse 2, and/or the metaverse 3) as if the one or more participants were present in the customized metaverse environment. For example, the server device 205 may implement one or more communication tools, collaboration features, and/or navigation options, among other examples, to enable the user to interact with the customized metaverse environment.

In some examples, the one or more participation ratios may be based on a progress of the event, enabling the one or more customization rules to dynamically adapt as the event progresses. For example, during an initial stage of a virtual conference, a participation ratio may be set to prioritize interactions with attendees from a given metaverse environment (e.g., from the multiple first metaverse environment) associated with introductory networking, such as the metaverse 1. As the conference progresses to a panel discussion, the participation ratio may shift to include a greater proportion of participants from a metaverse environment associated with the topic of the panel (such as the metaverse 2), facilitating more in-depth and relevant conversations. Similarly, in a virtual music festival, a participation ratio may change to prioritize attendees from a metaverse environment featuring a specific artist or genre of music as the corresponding performance approaches, creating a more immersive and engaging experience for users. By the server device 205 adjusting the participation ratios based on the event’s progress, the server device 205 can create a more engaging, context-dependent, and evolving environment that mirrors the natural flow of the event.

As shown by reference number 255, the server device 205 may transmit, and the client device 210 may receive, display information for the customized metaverse environment. For example, the display information may enable the client device 210 to render and/or display the customized metaverse environment. As shown by reference number 260, the client device 210 may display the customized metaverse environment. For example, after receiving the display information, the client device 210 may utilize a graphics processing unit (GPU) or other processing unit and/or display hardware to render the customized metaverse environment, such as including 3D graphics, audio, and/or other multimedia elements. The client device 210 may display the customized metaverse environment on a display screen, such as a monitor, tablet, headset, goggles, smartphone screen, and/or a peripheral device, among other examples, thereby enabling the user to interact with and experience the customized metaverse environment. The display information may include instructions for updating the customized metaverse environment in real-time, enabling the client device 210 to reflect changes to the customized metaverse environment, such as the movement of other participants and/or updates to the layout of the customized metaverse environment, among other examples.

As shown in FIG. 2C, and by reference number 265, the client device 210 may transmit, and the server device 205 may receive, user interaction information for the customized metaverse environment. For example, the server device 205 may obtain, based on the user interaction information in the second metaverse environment, one or more interaction parameters for a user participating in the second metaverse environment. The one or more interaction parameters indicate an excitement level, an interaction level, an engagement level, and/or another parameter indicative of user interaction within the customized metaverse environment.

In some examples, the one or more interaction parameters may be based on sentiment analysis, biometric information of the user, user feedback from the user, biometric information, and/or a user engagement level, among other examples. For example, the server device 205 may quantify user excitement levels within the customized metaverse environment. For example, the server device 205 may track one or more user interactions, engagement levels, feedback, and/or other relevant data to determine the one or more interaction parameters. In some examples, the server device 205 may perform real-time monitoring to track user interactions and/or excitement levels within the customized metaverse environment.

To determine the one or more interaction parameters, the server device 205 may analyze user interaction information received from the client device 210. For example, the server device 205 may use sentiment analysis techniques, such as natural language processing (NLP) or machine learning algorithms, to analyze user feedback, chat logs, and/or other text-based inputs. The sentiment analysis may categorize user sentiments as positive, negative, or neutral, and quantify the intensity of the sentiment. For instance, if a user input is “This is amazing!” in a chat log, the sentiment analysis may categorize the sentiment as positive and assign a score of 8/10, indicating a high level of excitement.

Additionally, or alternatively, the server device 205 may use biometric information, such as heart rate, skin conductance, and/or facial expressions, among other examples, to determine the one or more interaction parameters. For example, if a user is wearing a wearable device that tracks heart rate and skin conductance, the server device 205 may receive this biometric information (e.g., a heart rate and/or skin conductance) and use the biometric information to infer the excitement level of the user. For example, if the heart rate and/or skin conductance increase significantly while interacting with a particular virtual object or metaverse environment, then server device 205 may determine that the user is experiencing a high level of excitement.

To quantify excitement levels or engagement levels, the server device 205 may use various metrics, such as interaction frequency, dwell time, and/or attention metrics. For example, the server device 205 may track how often the user interacts with a particular virtual object or environment, how long the user’s avatar stays in a particular area or metaverse environment, or how much attention the user devotes to a particular task, among other examples. The server device 205 may combine the metrics with other data (such as sentiment analysis and/or biometric data, among other examples) to determine an overall excitement level or engagement level for the user in the customized metaverse environment. For example, if the user interacts frequently with a virtual object, stays in the area for an extended period, and exhibits positive sentiments and high levels of excitement (as inferred from biometric data or sentiment analysis), the server device 205 may assign an excitement level of 9/10 or an engagement level of 8/10.

The server device 205 may use one or more interaction parameters to adjust the customized metaverse environment in real-time, ensuring that the user remains engaged and excited. For example, the server device 205 may use the one or more interaction parameters to adapt the customized metaverse environment as the user engages with the customized metaverse environment. In some examples, the server device 205 may use machine learning models to provide personalized recommendations for the user to optimize the second metaverse environment. For example, the server device 205 may recommend specific environment combinations or customizations based on past behaviors and the one or more interaction parameters. For example, the server device 205 may indicate one or more updated customization rules and/or updates participation ratios, among other examples, as explained in more detail below.

As shown by reference number 270, the server device 205 may determine one or more updated customization rules for the customized metaverse environment based on the interaction information. For example, the server device 205 may modify, based on the one or more interaction parameters, the one or more customization rules to obtain one or more second participation ratios (e.g., one or more updated participation ratios) for the multiple first metaverse environments, such as the metaverse 1, the metaverse 2, and/or the metaverse 3. The one or more updated participation ratios may include an updated participation ratio 240′ (e.g., for the metaverse 1), an updated participation ratio 245′ (e.g., for the metaverse 2), and/or an updated participation ratio 250′ (e.g., for the metaverse 3). The updated participation ratio 240′, the updated participation ratio 245′, and/or the updated participation ratio 250′ may be similar to the participation ratios described above (e.g., the participation ratio 240, the participation ratio 245, and/or the participation ratio 250), but with different values. In some examples, the server device 205 may determine the one or more updated customization rules for the customized metaverse environment to maintain an excitement level of the user and/or to increase an excitement level of the user.

For example, the server device 205 may determine the one or more updated customization rules based on determining that a change in a value of an interaction parameter, from the one or more interaction parameters, satisfies a threshold. For example, the server device 205 may determine, based on the change in the value satisfying the threshold, the one or more updated participation ratios. As an example, if a change in an excitement level over a time window satisfies a threshold, then the server device 205 may update a participation ratio for one or more metaverse environments that the user was interacting with during the time window. For example, if the change in the excitement level indicates an increased level of excitement, then the server device 205 may update a participation ratio to cause the user to interact with a given metaverse environment (e.g., that the user was interacting with when the excitement level increased) more often (e.g., by increasing the participation ratio for the given metaverse environment and/or by decreasing participation ratios for one or more other metaverse environments). As another example, if the change in the excitement level indicates a decreased level of excitement, then the server device 205 may update a participation ratio to cause the user to interact with a given metaverse environment (e.g., that the user was interacting with when the excitement level increased) less (e.g., by decreasing the participation ratio for the given metaverse environment and/or by increasing participation ratios for one or more other metaverse environments).

As shown by reference number 275, the server device 205 may configure (e.g., reconfigure) the customized metaverse environment based on the one or more updated customization rules. For example, the server device 205 may configure the customized metaverse environment in a similar manner as described in connection with FIG. 2B and reference number 235, but using the one or more updated customization rules (e.g., the one or more updated participation ratios). For example, the server device 205 may configure the second metaverse environment based on the one or more updated participation ratios.

For example, the server device 205 may utilize a rendering engine to re-render the customized metaverse environment in real-time based on the one or more updated customization rules. The rendering engine may use various rendering techniques, such as ray tracing, rasterization, and/or photon mapping, among other examples to generate 3D graphics and visuals for the customized metaverse environment.

To improve the likelihood of a seamless and smooth transition as viewed by the user, the server device 205 may employ one or more optimization techniques, such as caching, buffering, and/or interpolation, to minimize lag, latency, and/or glitches when updating the customized metaverse environment. The server device 205 may use predictive modeling and/or machine learning algorithms to anticipate and prepare for future updates to the one or more customization rules, enabling more efficient reconfiguration. For example, the server device 205 may use a predictive model to forecast the likelihood of switching between different participation ratios or customization rules based on historical behavior and preferences and/or the one or more interaction parameters.

As shown by reference number 280, the server device 205 may transmit, and the client device 210 may receive, display information for the updated (or reconfigured) customized metaverse environment. The display information may include similar information as the display information described in connection with FIG. 2B and reference number 255. As shown by reference number 285, the client device 210 may display the updated customized metaverse environment. For example, the client device 210 may render and/or display the updated customized metaverse environment in a similar manner as described in connection with FIG. 2B and reference number 260.

For example, after the customized metaverse environment has been reconfigured by the server device 205, the server device 205 may transmit the updated environment data to the client device 210. The client device 210 may render and display the updated customized metaverse environment to the user. The real-time dynamic updating of the customized metaverse environment may improve performance for the multi-metaverse environment for the event. For example, by the server device 205 reconfiguring the customized metaverse environment in real-time, the server device 205 can transmit the updated environment data to the client device 210 with minimal delay, enabling the user to experience the changes in the customized metaverse environment with minimal interruption. This is beneficial in applications where real-time interaction is performed, such as in virtual events, social gatherings, and/or collaborative workspaces, among other examples. Additionally, by enabling the server device 205 to reconfigure the customized metaverse environment on the fly (e.g., in real-time), the server device 205 may accommodate changing user demands and preferences without the need for manual intervention or downtime. This can be useful in scenarios where user demand is unpredictable or fluctuates rapidly, such as in virtual events in multi-metaverse environments.

As indicated above, FIGS. 2A-2C are provided as an example. Other examples may differ from what is described with regard to FIGS. 2A-2C.

FIG. 3 is a diagram of example components of a device 300 associated with dynamic customization for multi-metaverse environments. The device 300 corresponds to one or more of the computer 102, the server device 205, and/or the client device 210. In some implementations, the computer 102, the server device 205, and/or the client device 210 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

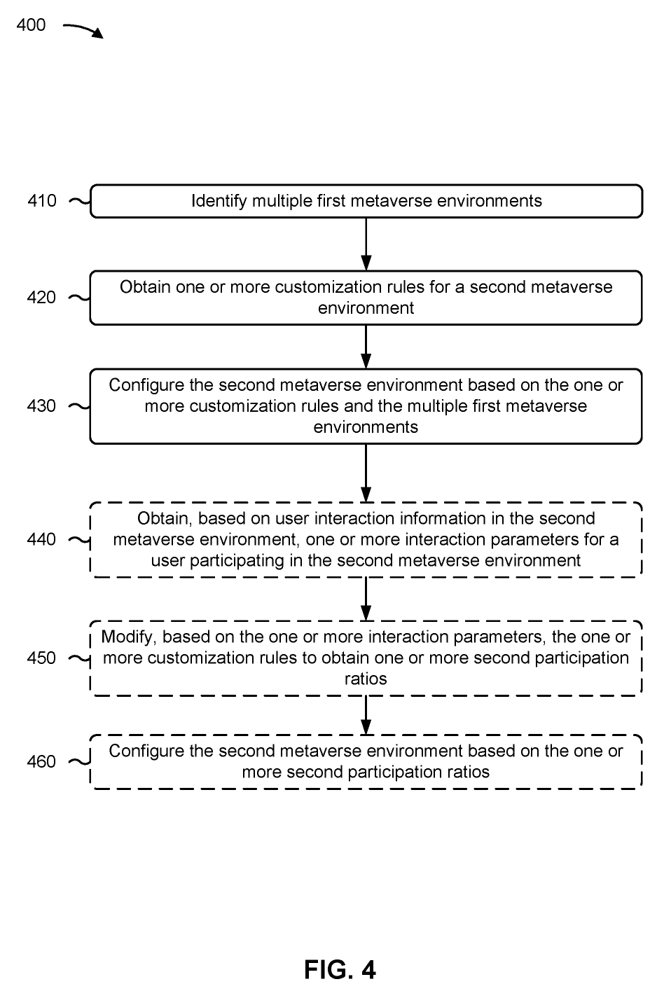

FIG. 4 is a flowchart of an example process 400 associated with dynamic customization for multi-metaverse environments. One or more process blocks of FIG. 4 are performed by a server device (e.g., server device 205 or computer 102) and/or by another device or a group of devices separate from or including the server device, such as a client device (e.g., the client device 210). Additionally, or alternatively, one or more process blocks of FIG. 4 may be performed by one or more components of device 300, such as processor 320, memory 330, input component 340, output component 350, and/or communication component 360.

As shown in FIG. 4, process 400 includes identifying multiple first metaverse environments that are each associated with an event (block 410). For example, the server device may identify multiple first metaverse environments that are each associated with an event, as described above.

As further shown in FIG. 4, process 400 includes obtaining one or more customization rules for a second metaverse environment associated with the event (block 420). For example, the server device may obtain one or more customization rules for a second metaverse environment associated with the event, as described above. In some implementations, the one or more customization rules indicate one or more first participation ratios for respective metaverse environments from the multiple first metaverse environments.

As further shown in FIG. 4, process 400 includes configuring the second metaverse environment based on the one or more customization rules and the multiple first metaverse environments (block 430). For example, the server device may configure the second metaverse environment based on the one or more customization rules and the multiple first metaverse environments, as described above.

As further shown in FIG. 4, process 400 includes obtaining, based on user interaction information in the second metaverse environment, one or more interaction parameters for a user participating in the second metaverse environment (block 440). For example, the server device may obtain, based on user interaction information in the second metaverse environment, one or more interaction parameters for a user participating in the second metaverse environment, as described above. In some implementations, the one or more interaction parameters indicate at least one of an excitement level or an interaction level.

As further shown in FIG. 4, process 400 includes modifying, based on the one or more interaction parameters, the one or more customization rules to obtain one or more second participation ratios (block 450). For example, the server device may modify, based on the one or more interaction parameters, the one or more customization rules to obtain one or more second participation ratios, as described above.

As further shown in FIG. 4, process 400 includes configuring the second metaverse environment based on the one or more second participation ratios (block 460). For example, the server device may configure the second metaverse environment based on the one or more second participation ratios, as described above.

Process 400 may include additional aspects, such as any single aspect or any combination of aspects described below and/or in connection with one or more other processes described elsewhere herein.

In a first aspect, the obtaining of the one or more customization rules includes obtaining a user input indicating the one or more first participation ratios. In a second aspect, alone or in combination with the first aspect, the second metaverse environment is associated with the user, and where the obtaining of the one or more customization rules includes determining the one or more customization rules based on historical interactions of the user for one or more historical multi-metaverse environments.

In a third aspect, alone or in combination with one or more of the first and second aspects, the configuring of the second metaverse environment based on the one or more customization rules includes causing a set of participants to be included in the second metaverse environment, where the set of participants are associated with the multiple first metaverse environments, and where a ratio of the set of participants from the multiple first metaverse environments is based on the one or more first participation ratios.

In a fourth aspect, alone or in combination with one or more of the first through third aspects, the configuring of the second metaverse environment based on the one or more customization rules includes causing an avatar of the user to view the multiple first metaverse environments over a time window, where an amount of time that the avatar views each metaverse environment, from the multiple first metaverse environments, is based on the one or more first participation ratios.

In a fifth aspect, alone or in combination with one or more of the first through fourth aspects, the one or more interaction parameters include at least one of a sentiment analysis, biometric information of the user, user feedback from the user, or a user engagement level. In a sixth aspect, alone or in combination with one or more of the first through fifth aspects, the one or more customization rules indicate that the one or more first participation ratios are based on a progress of the event.

In a seventh aspect, alone or in combination with one or more of the first through sixth aspects, process 400 includes providing an indication of the one or more customization rules to a rule-sharing platform.

In an eighth aspect, alone or in combination with one or more of the first through seventh aspects, the modifying of the one or more customization rules to obtain the one or more second participation ratios includes determining that a change in a value of an interaction parameter, from the one or more interaction parameters, satisfies a threshold, and determining, based on the change in the value satisfying the threshold, the one or more second participation ratios.

In a ninth aspect, alone or in combination with one or more of the first through eighth aspects, the configuring of the second metaverse environment based on the one or more customization rules includes causing one or more virtual components from the multiple first metaverse environments to be available in the second metaverse environment, where a ratio of which metaverse environments the one or more virtual components are from is based on the one or more first participation ratios.

In a tenth aspect, alone or in combination with one or more of the first through ninth aspects, the one or more virtual components include at least one of a virtual avatar, a virtual asset, or a virtual object.

Although FIG. 4 shows example blocks of process 400, in some implementations, process 400 includes additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various aspects of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
identifying multiple first metaverse environments that are each associated with an event;
obtaining one or more customization rules for a second metaverse environment associated with the event, wherein the one or more customization rules indicate one or more first participation ratios for respective metaverse environments from the multiple first metaverse environments;
configuring the second metaverse environment based on the one or more customization rules and the multiple first metaverse environments;
obtaining, based on user interaction information in the second metaverse environment, one or more interaction parameters for a user participating in the second metaverse environment, wherein the one or more interaction parameters indicate at least one of an excitement level or an interaction level;
modifying, based on the one or more interaction parameters, the one or more customization rules to obtain one or more second participation ratios; and
configuring the second metaverse environment based on the one or more second participation ratios.

2. The method of claim 1, wherein the obtaining of the one or more customization rules comprises:
obtaining a user input indicating the one or more first participation ratios.

3. The method of claim 1, wherein the second metaverse environment is associated with the user, and wherein the obtaining of the one or more customization rules comprises:
determining the one or more customization rules based on historical interactions of the user for one or more historical multi-metaverse environments.

4. The method of claim 1, wherein the configuring of the second metaverse environment based on the one or more customization rules comprises:
causing a set of participants to be included in the second metaverse environment, wherein the set of participants are associated with the multiple first metaverse environments, and wherein a ratio of the set of participants from the multiple first metaverse environments is based on the one or more first participation ratios.

5. The method of claim 1, wherein the configuring of the second metaverse environment based on the one or more customization rules comprises:
causing an avatar of the user to view the multiple first metaverse environments over a time window, wherein an amount of time that the avatar views each metaverse environment, from the multiple first metaverse environments, is based on the one or more first participation ratios.

6. The method of claim 1, wherein the one or more interaction parameters include at least one of a sentiment analysis, biometric information of the user, user feedback from the user, or a user engagement level.

7. The method of claim 1, wherein the one or more customization rules indicate that the one or more first participation ratios are based on a progress of the event.

8. The method of claim 1, further comprising:
providing an indication of the one or more customization rules to a rule-sharing platform.

9. The method of claim 1, wherein the modifying of the one or more customization rules to obtain the one or more second participation ratios comprises:
determining that a change in a value of an interaction parameter, from the one or more interaction parameters, satisfies a threshold; and
determining, based on the change in the value satisfying the threshold, the one or more second participation ratios.

10. The method of claim 1, wherein the configuring of the second metaverse environment based on the one or more customization rules comprises:
causing one or more virtual components from the multiple first metaverse environments to be available in the second metaverse environment, wherein a ratio of which metaverse environments the one or more virtual components are from is based on the one or more first participation ratios.

11. The method of claim 10, wherein the one or more virtual components include at least one of:
a virtual avatar,
a virtual asset, or
a virtual object.

12. A computer system comprising:
a processor set;
one or more computer-readable storage media; and
program instructions stored on the one or more computer-readable storage media to cause the processor set to perform operations comprising:
identifying multiple first metaverse environments;
obtaining one or more customization rules for a second metaverse environment, wherein the one or more customization rules indicate one or more first participation ratios for respective metaverse environments from the multiple first metaverse environments;
configuring the second metaverse environment based on the one or more customization rules and the multiple first metaverse environments;
obtaining, based on user interaction information in the second metaverse environment, one or more interaction parameters for a user participating in the second metaverse environment, wherein the one or more interaction parameters indicate at least one of an excitement level or an interaction level;
modifying, based on the one or more interaction parameters, the one or more customization rules to obtain one or more second participation ratios; and
configuring the second metaverse environment based on the one or more second participation ratios.

13. The computer system of claim 12, wherein the second metaverse environment is associated with the user, and wherein the obtaining of the one or more customization rules comprises:
determining the one or more customization rules based on historical interactions of the user for one or more historical multi-metaverse environments.

14. The computer system of claim 12, wherein the configuring of the second metaverse environment based on the one or more customization rules comprises:
causing a set of participants to be included in the second metaverse environment, wherein the set of participants are associated with the multiple first metaverse environments, and wherein a ratio of the set of participants from the multiple first metaverse environments is based on the one or more first participation ratios.

15. The computer system of claim 12, wherein the configuring of the second metaverse environment based on the one or more customization rules comprises:
causing an avatar of the user to view the multiple first metaverse environments over a time window, wherein an amount of time that the avatar views each metaverse environment, from the multiple first metaverse environments, is based on the one or more first participation ratios.

16. The computer system of claim 12, wherein the modifying of the one or more customization rules to obtain the one or more second participation ratios comprises:
determining that a change in a value of an interaction parameter, from the one or more interaction parameters, satisfies a threshold; and
determining, based on the change in the value satisfying the threshold, the one or more second participation ratios.

17. The computer system of claim 12, wherein the configuring of the second metaverse environment based on the one or more customization rules comprises:
causing one or more virtual components from the multiple first metaverse environments to be available in the second metaverse environment, wherein a ratio of which metaverse environments the one or more virtual components are from is based on the one or more first participation ratios.

18. A computer program product comprising:
one or more computer-readable storage media; and
program instructions stored on the one or more computer-readable storage media to perform operations comprising:
identifying multiple first metaverse environments;
obtaining one or more customization rules for a second metaverse environment, wherein the one or more customization rules indicate one or more first participation ratios for respective metaverse environments from the multiple first metaverse environments;
configuring the second metaverse environment based on the one or more customization rules and the multiple first metaverse environments;
obtaining, based on user interaction information in the second metaverse environment, one or more interaction parameters for a user participating in the second metaverse environment, wherein the one or more interaction parameters indicate at least one of an excitement level or an interaction level;
modifying, based on the one or more interaction parameters, the one or more customization rules to obtain one or more second participation ratios; and
configuring the second metaverse environment based on the one or more second participation ratios.

19. The computer program product of claim 18, wherein the configuring of the second metaverse environment based on the one or more customization rules comprises:
causing a set of participants to be included in the second metaverse environment, wherein the set of participants are associated with the multiple first metaverse environments, and wherein a ratio of the set of participants from the multiple first metaverse environments is based on the one or more first participation ratios.

20. The computer program product of claim 18, wherein the configuring of the second metaverse environment based on the one or more customization rules comprises:
causing an avatar of the user to view the multiple first metaverse environments over a time window, wherein an amount of time that the avatar views each metaverse environment, from the multiple first metaverse environments, is based on the one or more first participation ratios.
